(19) United States
(12) Patent Application Publication
(10) Pub. No.: US 2002/0084560 A1
(43) Pub. Date: Jul. 4, 2002

(54) Shock absorbing device having air envelopes

(76) Inventor: Daniel Huang, Taichung Hsien (TW)

Correspondence Address: CHARLES E. BAXLEY, 5th Floor, 59 John Street, New York, NY, 10038, US

(21) Appl. No.: 09/752,320

(22) Filed: Jan. 2, 2001

(51) Int. Cl. F16F 9/24

(52) U.S. Cl. 267/64.15; 188/297

(57) ABSTRACT

A shock absorbing device includes two members movable relative to each other, and one or more air envelopes disposed between the members for cushioning purposes. One of the members is a housing having a chamber for slidably receiving a piston and a tube of the other member. A cover is secured to one end of the housing. The tube is slidably engaged through the cover. A pump includes a casing having an opening coupled to a port of the housing for pumping an air into the housing and for providing a pressurized air in the housing.

### BACKGROUND OF THE INVENTION

1. Field of the Invention

The present invention relates to a shock absorbing device, and more particularly to a shock absorbing device having one or more air envelopes.

2. Description of the Prior Art

Typical shock absorbing devices, such as for vehicles or the like, include a mechanical structure having one or more spring members, hydraulic oils, rubber materials, etc., for cushioning purposes. However, the characters or the materials of the rubber materials may be changed by the environment temperatures. The hydraulic oil may have leaking problems. The spring members may have a spring fatigue problem.

The present invention has arisen to mitigate and/or obviate the afore-described disadvantages of the conventional shock absorbing devices.

### SUMMARY OF THE INVENTION

The primary objective of the present invention is to provide a shock absorbing device having one or more air envelopes for providing the air cushioning effect for the shock absorbing device.

In accordance with one aspect of the invention, there is provided a shock absorbing device comprising a first member and a second member, means for guiding the first member to move relative to the second member, and one or more air envelopes disposed between the first member and the second member for cushioning purposes. The air envelopes may include different pressures for providing different cushioning effects to the shock absorbing device.

The first member is a housing including a chamber formed therein, the second member includes a tube slidably engaged in the housing and engaged with the at least one air envelope.

The second member further includes a piston secured to the tube and slidably engaged in the housing and engaged with the at least one air envelope.

The first member includes a first end having a cover secured thereto, the tube is slidably engaged through the cover.

A pump is further provided for pumping the housing and includes a port formed in the housing, a casing having an opening, a hose coupling the opening of the casing to the port of the housing, a piston slidably received in the casing, and means for moving the piston along the casing to force an air into the housing.

The moving means includes a pole secured to the piston for moving the piston along the casing. The moving means includes a cap secured to the casing and having an inner thread formed therein, the pole includes an outer thread threaded with the inner thread of the cap.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a cross sectional view of a shock absorbing device in accordance with the present invention;

FIGS. 2 and 3 are partial cross sectional views showing the body of the shock absorbing device and the pumping or the pressure adjusting device for the shock absorbing device; and

FIG. 4 is a plane view illustrating the other embodiment of the shock absorbing device.

### DETAILED DESCRIPTION OF THE PREFERRED EMBODIMENT

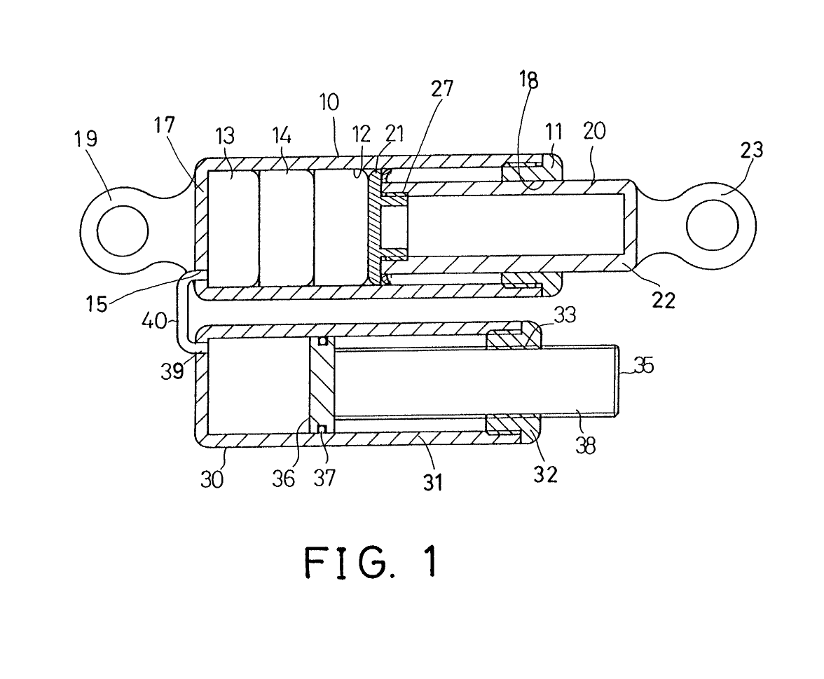

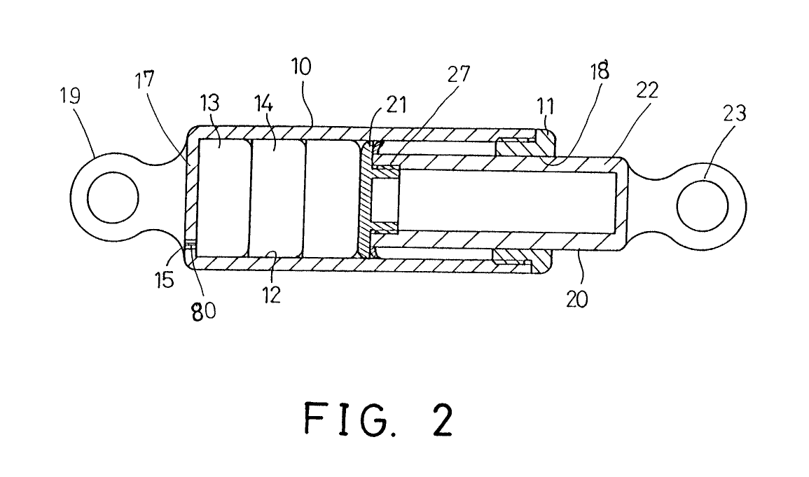

Referring to the drawings, and initially to FIGS. 1-3, a shock absorbing device in accordance with the present invention comprises two members 10, 20, slidably relative to each other, and one or more air envelopes 13, 14 disposed between the members 10, 20 for cushioning purposes. The first member 10 may be a housing 10, such as a cylindrical housing having a chamber 12 formed therein for receiving the air envelopes 13, 14, and having an end wall 17 provided on one end thereof, and having a cover 11 threaded to the other end thereof. The cover 11 includes a bore 18 formed therein. The members 10, 20 each has a ring 19, 23 for coupling to the other devices or mechanisms.

The second member 20 may be a rod or a tube 22 and includes a piston 21 slidably engaged in the chamber 12 of the housing 10, for engaging with the air envelopes 13, 14. The tube 22 is secured to the piston 21 with such as a threaded engagement 27, such that the piston 21 may be moved along the chamber 12 of the housing 10 and may be forced to engage with or to be disengaged from the air envelopes 13, 14 by the tube 22. The air envelopes 13, 14 may be filled with air of different pressures for forming different cushioning effects for the shock absorbing device. The end wall 17 of the housing 10 includes a port 15 having a valve 80 selectively engaged therein for selectively enclosing the chamber 12 of the housing 10.

A pump 30 includes a cylindrical casing 31 having an opening 39 formed in one end thereof for selectively coupling to the port 15 of the housing 10 with a hose 40 or the like. A cap 32 is threaded to the other end of the casing 31 and has an inner thread 33 formed therein. A piston 36 is slidably received in the casing 31. A sealing ring 37 is engaged between the piston 36 and the casing 31 for making an air tight seal between the piston 36 and the casing 31. A pole 35 includes an outer thread 38 formed thereon and threaded with the inner thread 33 of the cap 32 and secured to the piston 36 for moving the piston 36 along the casing 31 by threading or rotating the pole 35 relative to the casing 31.

In operation, as shown in FIG. 1, the pump 30 may be used to pump the air into or the draw the air out of the chamber 12 of the housing 10 when the valve 80 is disengaged from the port 15 of the housing 10 and when the hose 40 couples the pump 30 to the housing 10. The air received in the chamber 12 of the housing 10 and the air envelopes 13, 14 may thus be used to provide a cushioning effect between the two members 10, 20. The air envelopes 13, 14 may also be used for cushioning purposes when the valve 80 is removed or disengaged from the port 15 of the housing 10.

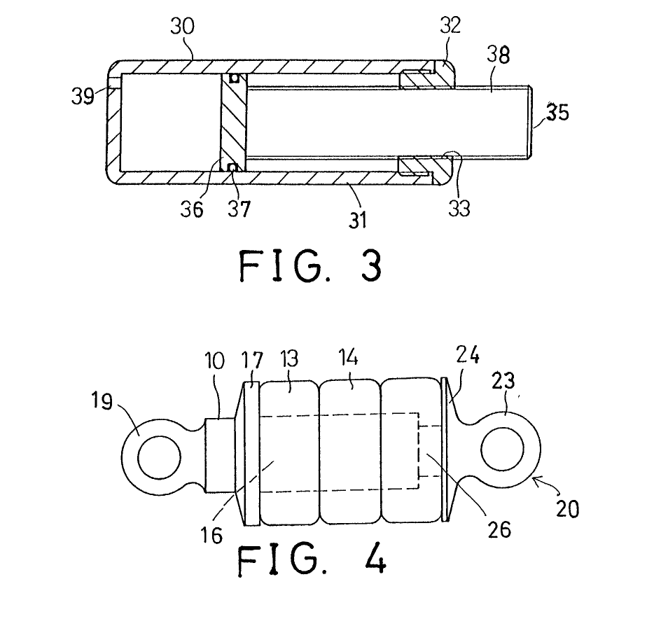

Referring next to FIG. 4, alternatively, the first member 10 may include a post 16 extended from the end wall 17. The air envelopes 13, 14 are engaged on and around the post 16. The second member 20 includes a panel 24 having a shaft 26 extended therefrom and slidably engaged in the post 16 of the first member 10, such that the members 10, 20 may be guided to move or to slide relative to each other by the sliding engagement of the shaft 26 in the post 16. The air envelopes 13, 14 are engaged between the end wall 17 and the panel 24 of the members 10, 20 for cushioning purposes.

Accordingly, the shock absorbing device in accordance with the present invention includes one or more air envelopes for providing the air cushioning effect for the shock absorbing device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A shock absorbing device comprising:
a first member and a second member movable relative to each other, and
at least one air envelope disposed between said first member and said second member for cushioning purposes.

2. The shock absorbing device according to claim 1, wherein said first member is a housing including a chamber formed therein, said second member includes a tube slidably engaged in said housing and engaged with said at least one air envelope.

3. The shock absorbing device according to claim 2, wherein said second member further includes a piston secured to said tube and slidably engaged in said housing and engaged with said at least one air envelope.

4. The shock absorbing device according to claim 2, wherein said first member includes a first end having a cover secured thereto, said tube is slidably engaged through said cover.

5. The shock absorbing device according to claim 2 further comprising means for pumping said housing.

6. The shock absorbing device according to claim 5, wherein said pumping means includes a port formed in said housing, a casing having an opening, a hose coupling said opening of said casing to said port of said housing, a piston slidably received in said casing, and means for moving said piston along said casing to force an air into said housing.

7. The shock absorbing device according to claim 6, wherein said moving means includes a pole secured to said piston for moving said piston along said casing.

8. The shock absorbing device according to claim 7, wherein said moving means includes a cap secured to said casing and having an inner thread formed therein, said pole includes an outer thread threaded with said inner thread of said cap.
